(19) United States
(12) Patent Application Publication
(10) Pub. No.: US 2024/0362247 A1
(43) Pub. Date: Oct. 31, 2024

(54) GRAPHICALLY REPRESENTING RELATIONSHIPS BETWEEN DATABASE RECORDS OF A DATABASE SYSTEM

(71) Applicant: Salesforce, Inc., San Francisco, CA (US)

(72) Inventors: Vidya Balakrishnan, San Francisco, CA (US); Aaron Wagoner, San Francisco, CA (US); Adheip Varadarajan, San Francisco, CA (US); Archana Sinha, San Francisco, CA (US); Jesus Fernandez, San Francisco, CA (US); Praveen Savur, San Francisco, CA (US); Preeti Dave, San Francisco, CA (US); Renzil Dourado, San Francisco, CA (US); Siemel Naran, San Francisco, CA (US); Shashank Shekhar, San Francisco, CA (US); Jason Liu, San Francisco, CA (US); Ashwin Kumar, San Francisco, CA (US)

(73) Assignee: Salesforce, Inc., San Francisco, CA (US)

(21) Appl. No.: 18/308,108

(22) Filed: Apr. 27, 2023

(51) Int. Cl. G06F 16/26; G06F 3/0482; G06F 3/0484

(52) U.S. Cl. CPC G06F 16/26; G06F 3/0482; G06F 3/0484

(57) ABSTRACT

A computing platform configurable to allow users to graphically represent relationships between database records may be provided to a plurality of organizations. A request to generate a customizable visualization for graphically representing relationships between a root database record and child database records in a customizable format may be processed. Graphical representations of the root database record and the child database records may be caused to be displayed in accordance with the customizable format.

### FIELD OF TECHNOLOGY

This patent document relates generally to on-demand software applications, and more specifically to graphically representing relationships between database records of a database system.

### Background

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

For example, such cloud computing services may be implemented via database system storing large numbers of database records. Such database records may be related in enormously complicated ways.

### BRIEF DESCRIPTION OF THE DRAWINGS

The included drawings are for illustrative purposes and serve only to provide examples of possible structures and operations for the disclosed inventive systems, apparatus, methods and computer program products for graphically representing relationships between database records of a database system. These drawings in no way limit any changes in form and detail that may be made by one skilled in the art without departing from the spirit and scope of the disclosed implementations.

FIG. 1 illustrates an example of a method for graphically representing relationships between database records of a database system, in accordance with one or more implementations.

FIG. 2 shows a block diagram of an example of a graphical representation configuration system, in accordance with some implementations.

FIGS. 3-10 show examples of Graphical User Interfaces (GUIs), in accordance with some implementations.

FIG. 11 shows a block diagram of an example of an environment that includes an on-demand database service configured in accordance with some implementations.

FIG. 12A shows a system diagram of an example of architectural components of an on-demand database service environment, configured in accordance with some implementations.

FIG. 12B shows a system diagram further illustrating an example of architectural components of an on-demand database service environment, in accordance with some implementations.

FIG. 13 illustrates one example of a computing device.

### DETAILED DESCRIPTION

Some implementations of the disclosed systems, apparatus, methods, and computer program products are configured for graphically representing relationships between database records of a database system. Such graphical representations of relationships between database records are also referred to herein as “relationship graphs.” As described in further detail below, the disclosed techniques may be implemented alone or in association with any type of computing platform, such as a Customer Relationship Management (CRM) Platform, a social networking system, any type of consumer or business software, etc. While CRM platforms (such as those provided by Salesforce®, Inc.) are discussed herein as an example of such a computing platform, one having skill in the art can appreciate that the examples of computing platforms described herein may be substituted for any suitable computing platform, such as those described above.

Traditional CRM systems, for example, often give a basic, single-level view of relationships between database records. Oftentimes, due to the simplistic way records are displayed and the lack of flexibility in ways to modify the way records are displayed, complex relationships between such records may be masked. By way of illustration, Isabella is a dermatologist at Measure for Measure Health, a comprehensive healthcare provider aiming to provide its patients with integrated care across specialties. Angelo, one of Isabella's patients, was diagnosed by his nephrologist at Measure for Measure Health with a genetic disorder that both hampers his kidney function and significantly increases his risk for melanoma. Unfortunately, Measure for Measure Health is unable to visualize patients' diagnostic relationships using the existing data visualization tools they employ; therefore, Isabella is remains unaware that Angelo is at high risk for melanoma, missing out on potential early screening and treatment.

By contrast, the disclosed techniques may be implemented to explore layers of relationships and related records, allowing users to configure exactly how and what types of relationships they wish to display. Furthermore, the disclosed techniques allow users to configure how these relationships are displayed (e.g., vertically, horizontally, or even radially.) Returning to the above example, Measure for Measure Health would be able to utilize the disclosed techniques to visualize patient health records across specialties and graphically represent relationships between such records. Isabella, therefore, would be able to see that Angelo is at a very high risk of developing melanoma. She could screen him early and often, identifying melanomas well before they become problematic.

In some implementations, the disclosed techniques may leverage artificial intelligence (AI) such that new types of relationships between database records may be automatically suggested. Returning to the above example, an article was recently published that links Angelo's genetic condition with a higher risk of type-two diabetes. Therefore, using the disclosed techniques, Measure for Measure Health's computing platform may leverage AI to automatically identify the relationship between Angelo's condition and type-two diabetes and automatically recommend that a provider review this recommendation. A nutritionist from Measure for Measure Health may then notify Angelo of his increased risk of type-two diabetes and guide him through health measures he can take to avoid this negative health outcome, improving Angelo's quality of life and saving resources for Measure for Measure Health.

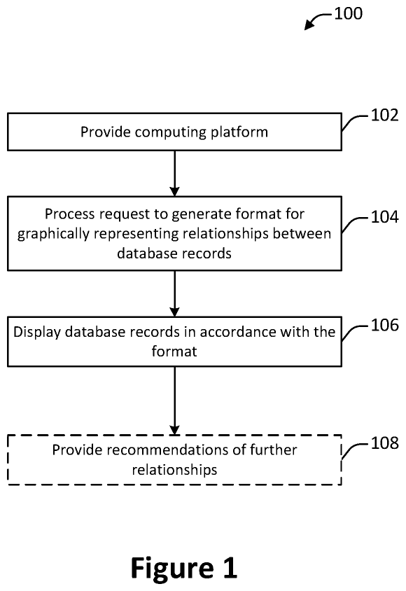

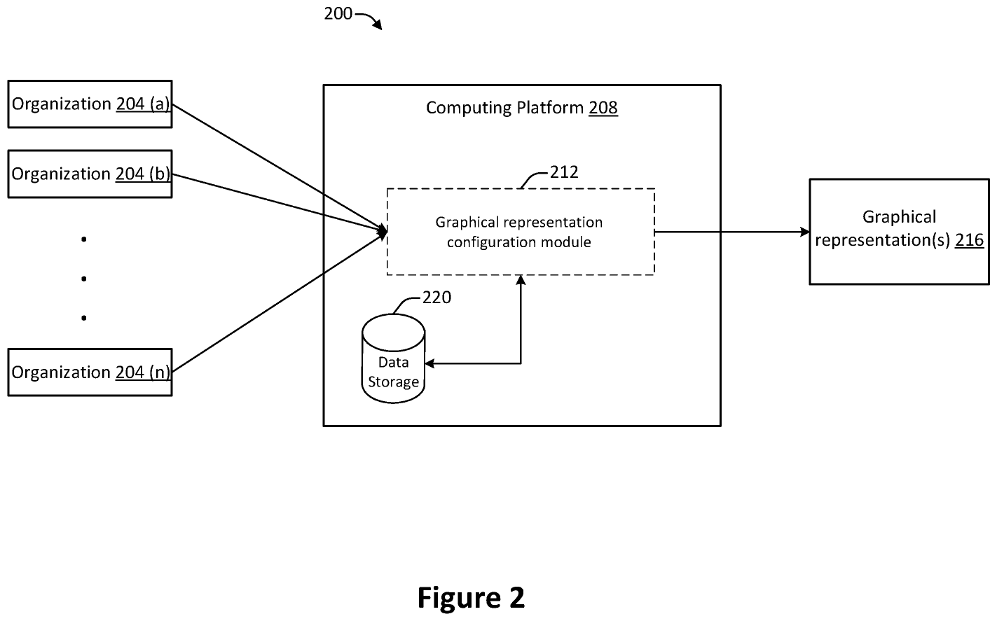

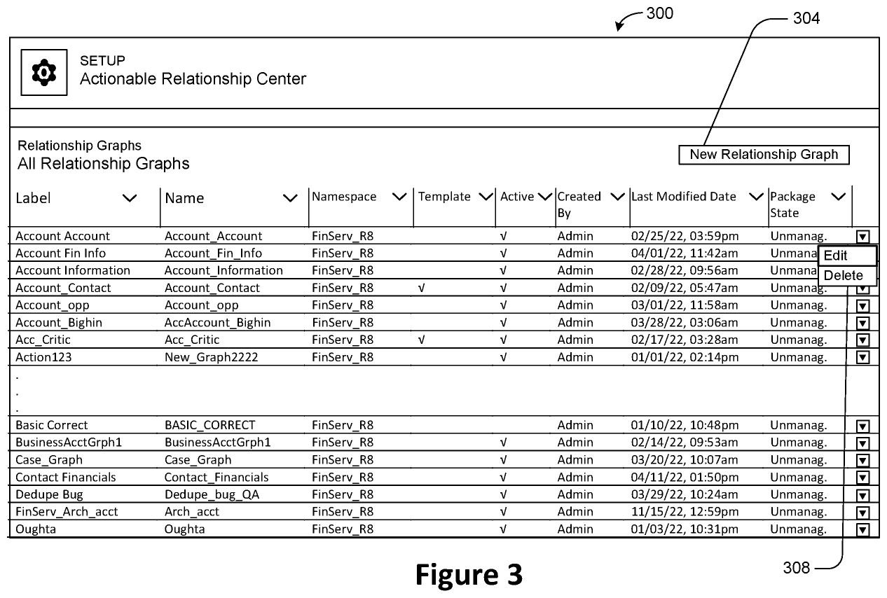

Referring now to the Figures, FIG. 1 illustrates an example of a method for graphically representing relationships between database records of a database system, in accordance with some implementations. FIG. 1 is discussed in the context of FIGS. 2-10. FIG. 2 shows a block diagram of an example of a graphical representation configuration system, in accordance with some implementations. FIGS. 3-10 show examples of Graphical User Interfaces (GUIs), in accordance with some implementations.

At 104 of FIG. 1, a computing platform is provided to a plurality of organizations. Such a computing platform may be provided in a variety of manners (e.g., via an on demand computing services environment implemented using database system using a server system, as described below.) As discussed below in the context of 108 of FIG. 1, the computing platform may be configurable to allow users to graphically represent relationships between database records of the database system.

The computing platforms described herein may be implemented in a variety of manners. By way of example, in relationship graph configuration environment 200 of FIG. 2, organizations 204(a)-(n) interact with computing platform 208. As discussed above, the computing platform 208 may be any type of computing platform and may have a variety of components such as a CRM Platform, a social networking system, any type of consumer or business software, etc.

The computing platform 208 includes a relationship graph configuration module 212, which may perform the web page and/or application configuration techniques disclosed herein. For instance, in some implementations, users affiliated with the organizations 204(a)-(n) may request configuration of graphical representations 216 of relationships between database records. The relationship graph configuration module 212 may process such requests to generate such graphical representations 216 of relationships between database records. By way of example, Measure for Measure Health may use a CRM platform, such as one provided by Salesforce®, Inc for configuration of their applications and/or web pages. The applications and/or web pages may be designable and/or customizable by authorized users affiliated with Measure for Measure Health. On behalf of Measure for Measure Health, Isabella may request configuration of a Measure for Measure Health patient health records application. In response to Isabella's request, as discussed below, the relationship graph configuration module 212 may access data stored in data storage 220 on behalf of the Measure for Measure Health organization. The relationship graph configuration module 212 may use this information, as well as information entered by Isabella into UIs of the computing platform 208, to configure the Measure for Measure Health patient health records application.

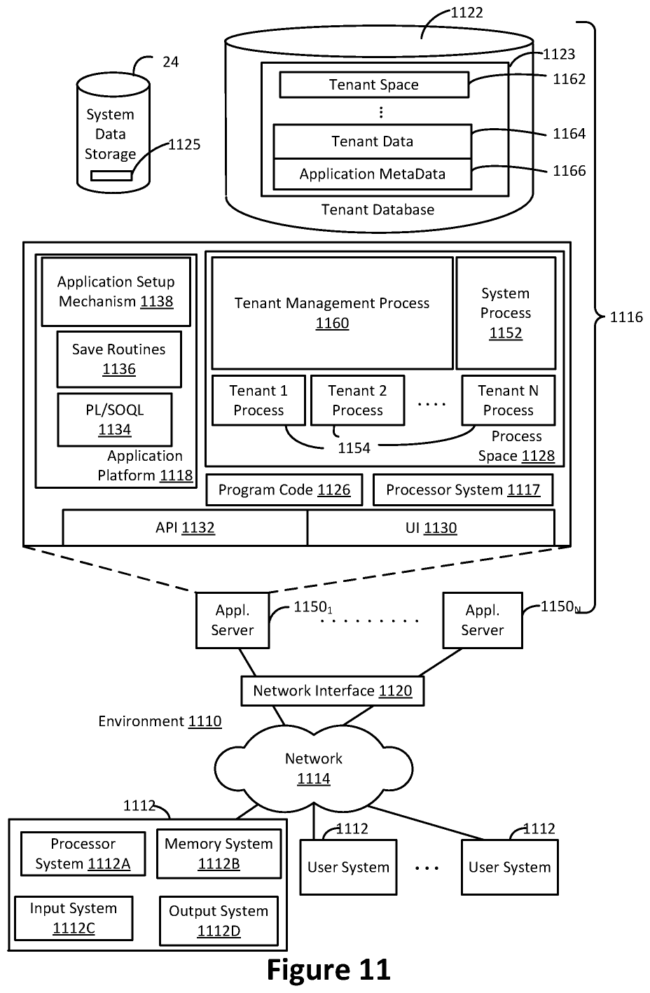

In some implementations, the computing platform 208 may be provided to the organizations 204(a)-(n) via an on-demand computing environment, as discussed further below in the context of FIGS. 11-13. By way of example, the computing platform 208 may be provided to the organizations 204(a)-(n) in a multi-tenant database system. Similar to tenant data storage 1122 of FIG. 11, data storage 220 of FIG. 2 may store data of the organizations 204(a)-(n) in a multi-tenant architecture. The relationship graph configuration module 212 may access the data storage 220 and use an organization's 204(a)-(n) data when a relationship graph is configured. Similarly, the relationship graph configuration module 212 may store metadata relating to an organization 204(a)-(n) such as branding information, etc. in the data storage 220. Returning to the above example, the relationship graph configuration module 212 may access Measure for Measure Health's data, which is stored in the data storage 220, when configuring a relationship graph for Measure for Measure Health. Once Isabella has provided information via UIs of the computing platform 208 to configure a relationship graph for Measure for Measure Health, the relationship graph configuration module 212 may cause the information provided by Isabella to be stored in the data storage 220.

Returning to FIG. 1, At 108, a request may be received at the computing platform from a user first user associated with a first one of the organizations (e.g., the organizations 204(a)-(n)). The request may be a request to generate a customizable visualization (e.g., a relationship graph) for graphically representing relationships between a root database record and child database records related to the root database in a database of the database system.

The request may be provided by the first user in a variety of manners, e.g. via user interface(s). By way of illustration, user interface 300 of FIG. 3 may be displayed on a computing device of a user. The user may click or tap “new relationship graph” button 304 to request to create a customizable visualization (e.g., a relationship graph) for graphically representing relationships between a root database record and child database records related to the root database in a database of the database system. Additionally, the user may click or tap menu 308 to delete or edit an existing relationship graph.

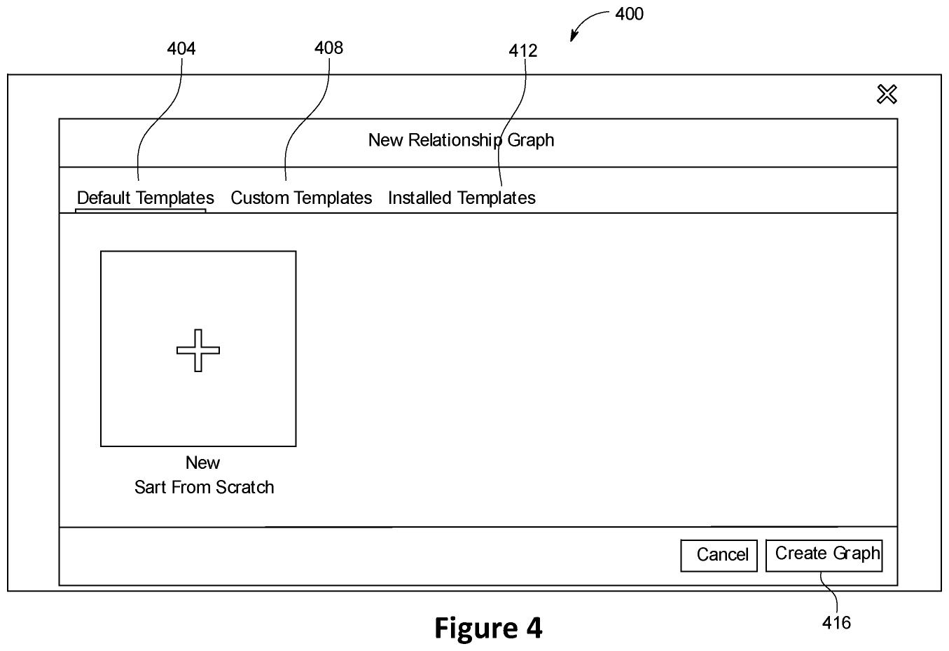

After clicking or tapping the new relationship graph button 304 of FIG. 3, user interface 400 of FIG. 4 may be displayed on the computing device. In FIG. 4, default templates 404 may allow a user to choose from relationship graph templates that the computing platform has created and may include for all customers. By way of example, such default relationship graph templates may come preloaded with objects, relationships, labels, display fields, actions, etc. In some implementations, such default relationship graph templates can be modified and built on top of by customers of the computing platform.

Also or alternatively, custom relationship templates may be provided. By way of illustration, in FIG. 4 custom templates 408 may allow a user to choose from relationship graph templates that a user may create on behalf of an organization, which can be stored on behalf of the organization as described above in the context of FIG. 2.

In some implementations, installed templates, such as installed templates 412 of FIG. 4, may allow a user to choose from relationship graph templates that come from a managed package.

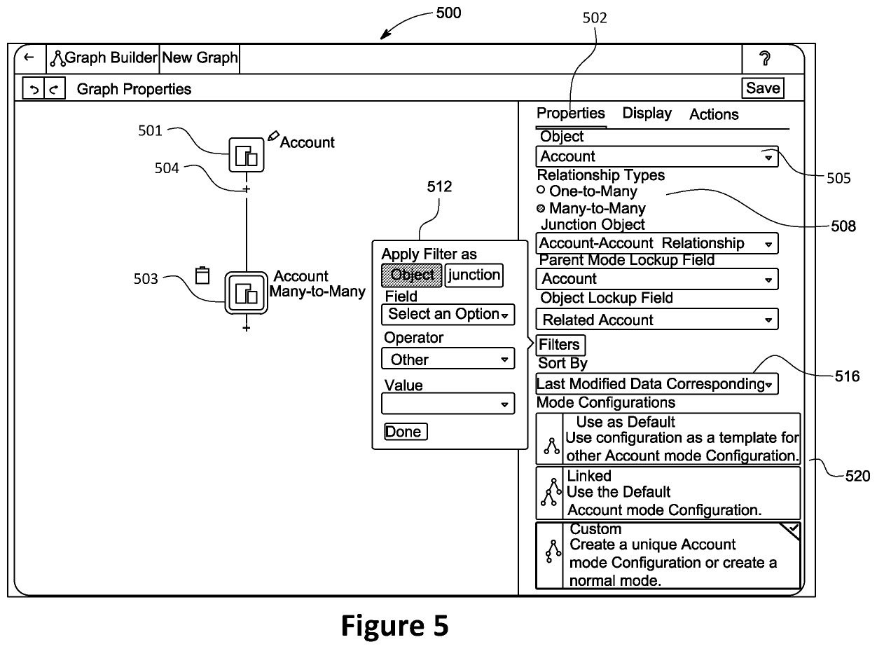

Once the user has chosen from which template to begin the new relationship graph, they may click or tap “create graph” button 416. After clicking or tapping the create graph button 416, the user may be presented with user interface 500 of FIG. 5. The user interface 500 of FIG. 5 may be used as a “builder” to generate and customize relationship graphs.

In some implementations, a relationship graph may contain a “root node” (e.g., a node of the relationship graph associated with the database record of interest) and one or more “child nodes” (e.g., one or more nodes of the relationship graph associated with database records related to the root node.) For instance, in the user interface 500, a user can configure and customize root node 501 on the graph by entering relevant information in the properties tab 502. The user may add child node(s) 503 to the relationship graph by clicking or tapping the plus icon 504. The user may then configure and customize the child node(s) 503 by entering relevant information in the properties tab 502.

In some implementations, a builder may contain a variety of components allowing users to generate and customize relationship graphs. For example, in the properties tab 502, “object selection menu” 505 may allow the user to select a type of database record to be graphically represented in the relationship graph. The user can choose whether to represent a custom or standard object.

Also or alternatively, “relationship configuration menu” 508 may allow the user to select what type of relationship to graphically represent in a relationship graph (e.g., a one-to-many-relationship or a many-to-many relationship). If selecting a many-to-many relationship, the user may select a “junction object” (e.g., a type of object to connect the database records that the user wishes to relate to each other in the relationship graph such as a “contact,” as described further below.)

One having skill in the art can appreciate that node configuration may vary across implementations and may have a variety of nuances and outcomes. For instance, a user may create a relationship graph with a contact as the root node and an opportunity as the child node. In this example, the user may create a “grandchild” node that is also a contact; however, the grandchild node may simply be a link to the root node. For example, in some implementations, the fields to display, the fonts, the child relationships, etc. may be automatically copied.

Another example may be illustrated based on an organizational chart where a contact may be connected to other contacts via a field such as the “Contact.ReportsTo” field. In this example, a relationship graph configuration would have only two nodes, but while viewing records it can grow deeper indefinitely with each contact and their team is viewed.

In some implementations, “filter menu” 512 may allow the user to control which records should be displayed in a “record container” (e.g., a graphical representation of the child nodes of a relationship graph, discussed and depicted in further detail below.) In the filter menu 512, the user may choose to filter based on either the junction object or target object fields.

Also or alternatively, “sort menu” 516 may allow the user to choose an order by which database records may be sorted in a relationship graph. By way of example, the user may choose to sort records by the target object field in either ascending or descending order.

In some implementations, “node configuration menu” 520 allows the user to configure how nodes are displayed in the relationship graph. For example, the node configuration menu 520 may allow the user to select a maximum amount of drilling (e.g., clicking or tapping to view further records) to be configured in the relationship graph or allow a user to drill infinitely into the relationship graph.

In some implementations, a user can customize the format of a relationship graph in a variety of manners. Such customizable formats may include a variety of features, including anything having to do with the layout or way in which content is displayed in a relationship graph, e.g., fonts, spatial configuration graphical representations of records (e.g. vertical, horizontal, radial, etc.), types of relationships to be displayed, etc. Such customizable formats are discussed in further detail below.

Also or alternatively, after building a definition of a relationship graph, as discussed above, the relationship graph may be placed on a page. By way of example, a user may edit a contact page and configure the contact page to display a relationship graph created by the user. Additionally, in some implementations, users may include pre-configured templates directly onto such a page.

Returning to FIG. 1, at 112, graphical representations (e.g., a relationship graph) of the root database record and the child database records is caused to be displayed in a user interface of a computing device. The graphical representations (e.g., the relationship graph) of the root database record and the child database records may be displayed in accordance with the customizable format as discussed above.

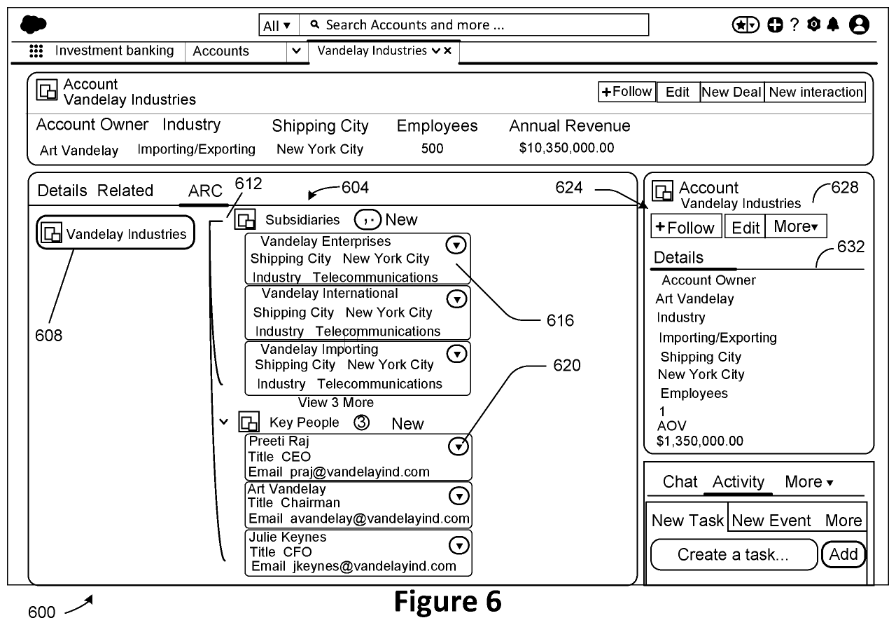

By way of illustration, user interface 600 of FIG. 6 contains an example of a relationship graph 604. A relationship graph may contain a variety of components and be displayed in a variety of customizable arrangements as discussed below. For instance, a relationship graph may depict a root record of interest and “record containers” that contain child records that are are related to the root record. The relationship graph may also show how the records in such record containers are related to the root record.

By way of example, in FIG. 6, root record 608, which is a database record representing the account for “Vanderlay Industries” is depicted along with record containers 612. The record containers 612 contain graphical representations of child records that are related to the root record 608. Each individual database record in a record container may be depicted in a “record card” such as record card 616. A record card may include a variety of information including the title or name of the database record being depicted in the record card. In some implementations, additional fields from the junction object or target object may be depicted in the record card. Also or alternatively, multiple database records may be collapsible into a single record card if multiple junction objects are present.

In some implementations, a user interacting with the relationship graph 604 may click or tap “embedded actions” button 620 to select an embedded action to be performed. An authorized user configuring the relationship graph 604 may choose any one action to be a “top level” action for the record cards. Additionally, any number of default and quick actions may be configured to be displayed in a popup when a user interacting with the relationship graph 604 clicks or taps the embedded actions button 620.

In some implementations, a user interface in which a relationship graph is displayed may also include a variety of other components and/or information. By way of illustration, the user interface 600 includes “decomposed side panel” 624. The decomposed side panel 624 contains information related to any record in the relationship graph 604 that is currently selected by a user, which in the example of FIG. 6 is the root record 608.

Also or alternatively, a side panel of a relationship graph (e.g., the decomposed side panel 624) may contain a variety of information. For instance, the decomposed side panel 624 includes “highlights component” 628 and “detail component” 632. The highlights component 628 depicts the name of the selected record and any quick actions that may be specified and configured by an authorized user configuring the relationship graph 604. The detail component 632 depicts fields of the selected record that may be specified and configured by an authorized user configuring the relationship graph 604.

One having skill in the art can appreciate that side panels may be flexible, and the disclosed techniques may be implemented with a variety of different side panels. By way of example, a relationship graph component may be configured to notify any side panel components on which a user focuses and/or selects on the relationship graph. While the detail, highlights, and Einstein Relationship are some examples of components that may be included by a computing platform, other side panels may highlight a variety of other foci associated with relationship graphs. In some implementations, users may develop their own side panel components to show other details of their choosing based on user focus and/or selection.

As discussed above, relationship graphs may be displayed in a variety of user customizable formats. By way of example, graphical representations of database records in relationship graphs may be displayed in a variety of user-selectable and customizable configurations by which the first relationships are graphically represented. By way of illustration, in FIG. 6, the root record 608 is displayed substantially horizontally adjacently to record containers 612. Such a configuration, as depicted in FIG. 6, where root records are displayed substantially horizontally adjacently to record containers is referred to herein as a “horizontal configuration.”

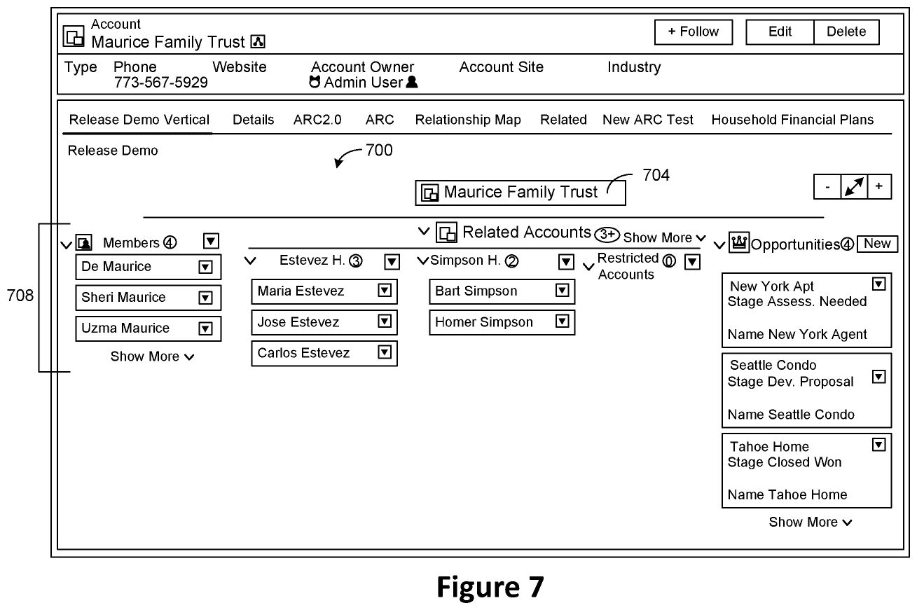

In an alternative configuration, FIG. 7 depicts relationship graph 700, in which a root record 704 is displayed substantially vertically adjacently to the record containers 708. Such a configuration, as depicted in FIG. 7, where root records are displayed substantially vertically adjacently to record containers is referred to herein as a “vertical configuration.”

One having skill in the art can appreciate that the relationship graphs can be displayed in any configuration and are not limited to vertical and horizontal configurations. For instance, a relationship graph may be displayed in a “radial configuration” where record containers are displayed in a pattern extending radially outwardly from a root record.

In some implementations, the user customizable formats may include a variety of additional user customizable features. By way of example, an organization may choose to depict their relationship graphs in alignment with a brand. The organization may select any fonts, colors, branding, etc. that they wish to be depicted in their relationship graphs. In this scenario each organization using the computing platform may choose to depict their relationship graphs differently.

In some implementations, returning to FIG. 1, at 116 a recommendation of further relationships between database records is provided. Such recommendations may be generated automatically in a variety of manners. By way of example, the computing platform may be implemented with an integrated comprehensive Artificial Intelligence (AI) system, such as Einstein® provided by Salesforce®, Inc. As one having skill in the art can appreciate, such an AI system may process database records stored in a database system of the computing platform and determine relationships between the database records. Also or alternatively, such recommendations may be generated via any other techniques such as a machine leaning algorithm using a variety of training data, predictions based on frequentist or Bayesian statistical inference, etc.

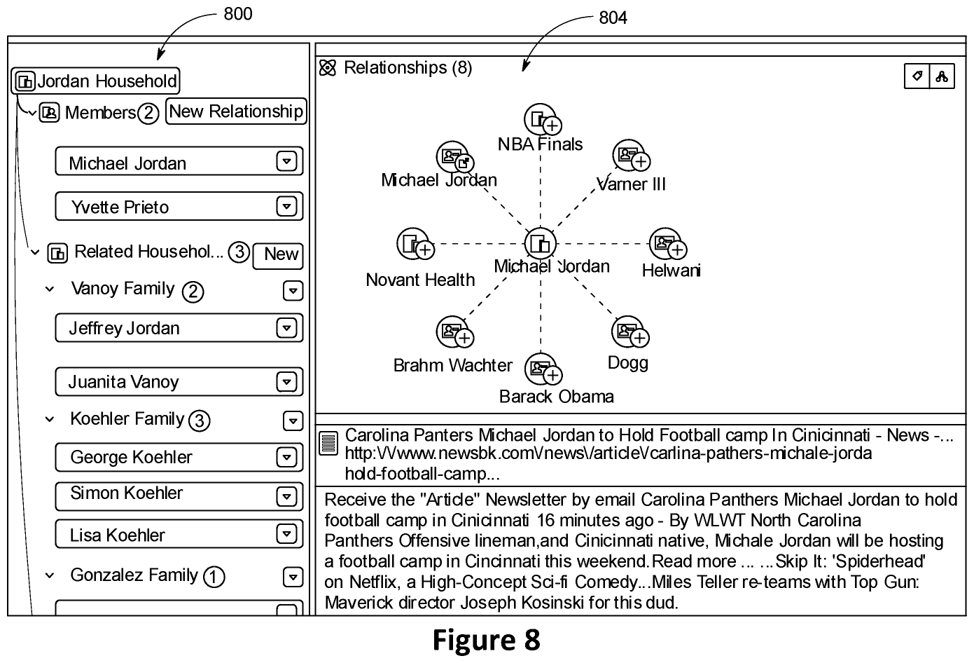

Also or alternatively, recommendations of further relationships between database records may be depicted and/or provided in a variety of manners. By way of example, in FIG. 8, Relationship Graph 800 is displayed next to Suggested Relationship Panel 804. The Suggested Relationship Panel 804 may depict suggested relationships to any record a user selects in the Relationship Graph 800.

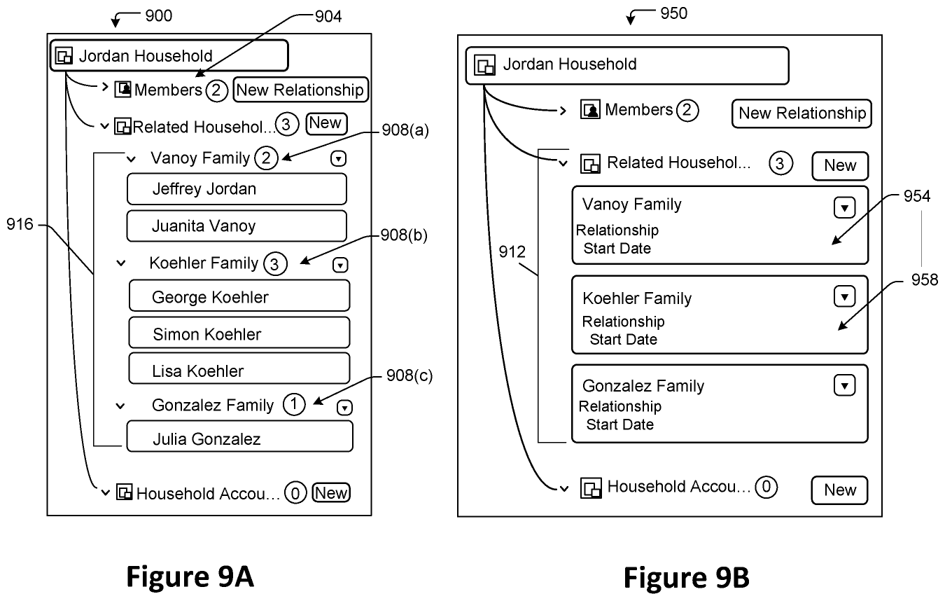

In some implementations, users may be able to view related information in a single pane, minimizing clicks. By way of example, record containers may be displayed in a split container layout in order to allow users interacting with a relationship graph to view additional information without needing to click or tap on any elements of the relationship graph. By way of illustration, in FIG. 9A, a user interacting with relationship graph 900 is able to view both members of the Jordan Household (Members group 904 that is depicted in a collapsed form in FIG. 9) in addition to extended family members (Vanoy 908(a), Koehler 908(b), and Gonzalez 908(c) families) from other households. A user can quickly view all of the people in the Jordan Household via the relationship graph 900 without excessive clicking and without navigating to a new page.

Alternatively, FIG. 9B depicts a relationship graph 950 which lacks the functionality allowing users to view related information in a single pane described above with respect to FIG. 9A. In contrast to FIG. 9A, in FIG. 9B, if the user interacting with relationship graph 950 wishes to see the household members of the Vanoy Family, for example, the user may click or tap on record card 954. After clicking or tapping the record card 954, record cards for “Jeffrey Jordan” and “Juanita Vanoy” may be depicted off the right in a new column. Additionally, in contrast to FIG. 9A, the user would also then not be able to see the members in the Koehler family and would need to then to go back and click or tap on the Koehler family record card 958 and navigate to those members thereby losing context of the Vanoy Family members.

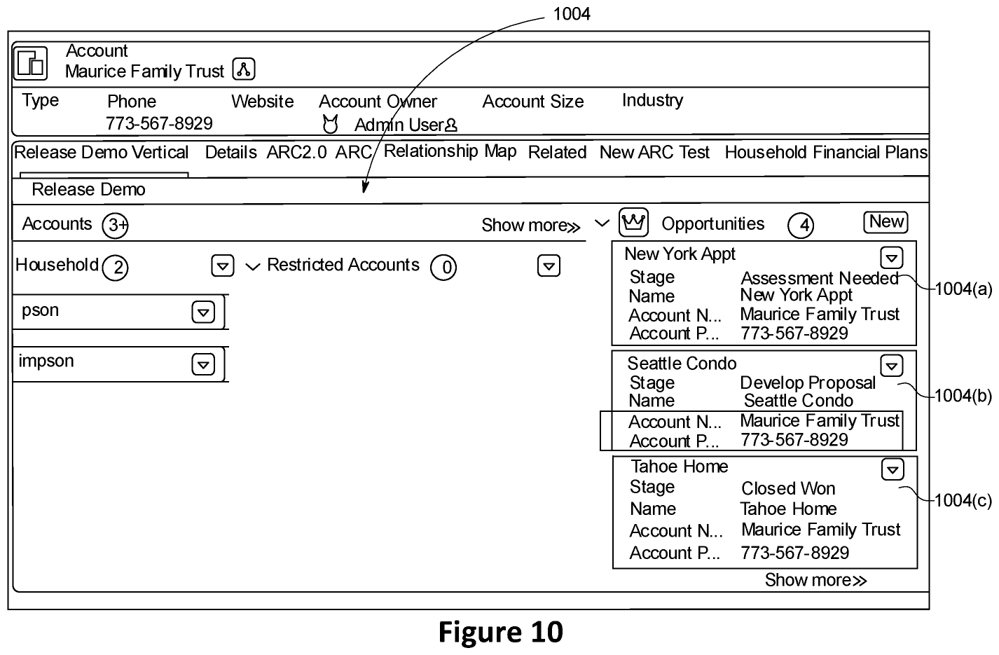

In some implementations, fields from multiple database records may be displayed in a single node of a relationship graph. By way of example, in relationship graph 1000 of FIG. 10, record cards 1004(a)-(c) each depict information related to a respective opportunity. Additionally, the record cards 1004(a)-(c) each also depict information related to the account (“Maurice Family Trust”), which is associated with each respective opportunity. One having skill in the art can appreciate that depiction of fields from multiple database records in a single node of a relationship graph may be applied to any type database record. Additionally, multiple database records may be depicted in a single node of a relationship graph in any of the configurations described herein such as a horizontal configuration, a vertical configuration, or a radial configuration.

In some implementations, a relationship graph may depict “peer objects” rather than merely database records with a parent-child relationship. In this instance, a user may configure depiction of such peer objects in a builder like that depicted in user interface 500 of FIG. 5.

Also or alternatively, a user configuring a relationship graph may create, customize and configure actions associated with record cards using a declarative scripting tool. By way of example, by using the OmniScript Designer provided by Salesforce®, Inc., the user may create such actions by clicking, dragging and dropping, rather than using computer program code. Such a tool may be integrated with the computing platform such that users may use the tool to create, customize and configure actions associated with record cards of relationship graphs.

FIG. 11 shows a block diagram of an example of an environment 1110 that includes an on-demand database service configured in accordance with some implementations. Environment 1110 may include user systems 1112, network 1114, database system 1116, processor system 1117, application platform 1118, network interface 1120, tenant data storage 1122, tenant data 1123, system data storage 1124, system data 1125, program code 1126, process space 1128, User Interface (UI) 1130, Application Program Interface (API) 1132, PL/SOQL 1134, save routines 1136, application setup mechanism 1138, application servers 1150-1 through 1150-N, system process space 1152, tenant process spaces 1154, tenant management process space 1160, tenant storage space 1162, user storage 1164, and application metadata 1166. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 1116, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1118 may be a framework that allows the creation, management, and execution of applications in system 1116. Such applications may be developed by the database service provider or by users or third-party application developers accessing the service. Application platform 1118 includes an application setup mechanism 1138 that supports application developers' creation and management of applications, which may be saved as metadata into tenant data storage 1122 by save routines 1136 for execution by subscribers as one or more tenant process spaces 1154 managed by tenant management process 1160 for example. Invocations to such applications may be coded using PL/SOQL 1134 that provides a programming language style interface extension to API 1132. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1166 for a subscriber making such an invocation. Such system processes may also manage execution of application metadata 1166 as an application in a virtual machine.

In some implementations, each application server 1150 may handle requests for any user associated with any organization. A load balancing function (e.g., an F5 Big-IP load balancer) may distribute requests to the application servers 1150 based on an algorithm such as least-connections, round robin, observed response time, etc. Each application server 1150 may be configured to communicate with tenant data storage 1122 and the tenant data 1123 therein, and system data storage 1124 and the system data 1125 therein to serve requests of user systems 1112. The tenant data 1123 may be divided into individual tenant storage spaces 1162, which can be either a physical arrangement and/or a logical arrangement of data. Within each tenant storage space 1162, user storage 1164 and application metadata 1166 may be similarly allocated for each user. For example, a copy of a user's most recently used (MRU) items might be stored to user storage 1164. Similarly, a copy of MRU items for an entire tenant organization may be stored to tenant storage space 1162. A UI 1130 provides a user interface and an API 1132 provides an application programming interface to system 1116 resident processes to users and/or developers at user systems 1112.

System 1116 may implement a web-based system for graphically representing relationships between database records of a database system. For example, in some implementations, system 1116 may include application servers configured to implement and execute software applications for graphically representing relationships between database records. The application servers may be configured to provide related data, code, forms, web pages and other information to and from user systems 1112. Additionally, the application servers may be configured to store information to, and retrieve information from a database system. Such information may include related data, objects, and/or Webpage content. With a multi-tenant system, data for multiple tenants may be stored in the same physical database object in tenant data storage 1122, however, tenant data may be arranged in the storage medium(s) of tenant data storage 1122 so that data of one tenant is kept logically separate from that of other tenants. In such a scheme, one tenant may not access another tenant's data, unless such data is expressly shared.

Several elements in the system shown in FIG. 11 include conventional, well-known elements that are explained only briefly here. For example, user system 1112 may include processor system 1112A, memory system 1112B, input system 1112C, and output system 1112D. A user system 1112 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1112 to access, process and view information, pages and applications available from system 1116 over network 1114. Network 1114 may be any network or combination of networks of devices that communicate with one another, such as any one or any combination of a LAN (local area network), WAN (wide area network), wireless network, or other appropriate configuration.

The users of user systems 1112 may differ in their respective capacities, and the capacity of a particular user system 1112 to access information may be determined at least in part by “permissions” of the particular user system 1112. As discussed herein, permissions generally govern access to computing resources such as data objects, components, and other entities of a computing system, such as a system for graphically representing relationships between database records, a social networking system, and/or a CRM database system. “Permission sets” generally refer to groups of permissions that may be assigned to users of such a computing environment. For instance, the assignments of users and permission sets may be stored in one or more databases of System 1116. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1116 may provide on-demand database service to user systems 1112 using an MTS arrangement. By way of example, one tenant organization may be a company that employs a sales force where each salesperson uses system 1116 to manage their sales process. Thus, a user in such an organization may maintain contact data, leads data, customer follow-up data, performance data, goals and progress data, etc., all applicable to that user's personal sales process (e.g., in tenant data storage 1122). In this arrangement, a user may manage his or her sales efforts and cycles from a variety of devices, since relevant data and applications to interact with (e.g., access, view, modify, report, transmit, calculate, etc.) such data may be maintained and accessed by any user system 1112 having network access.

When implemented in an MTS arrangement, system 1116 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1116 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1116 may also maintain system-level data usable by multiple tenants or other data. Such system-level data may include industry reports, news, postings, and the like that are sharable between tenant organizations.

In some implementations, user systems 1112 may be client systems communicating with application servers 1150 to request and update system-level and tenant-level data from system 1116. By way of example, user systems 1112 may send one or more queries requesting data of a database maintained in tenant data storage 1122 and/or system data storage 1124. An application server 1150 of system 1116 may automatically generate one or more SQL statements (e.g., one or more SQL queries) that are designed to access the requested data. System data storage 1124 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

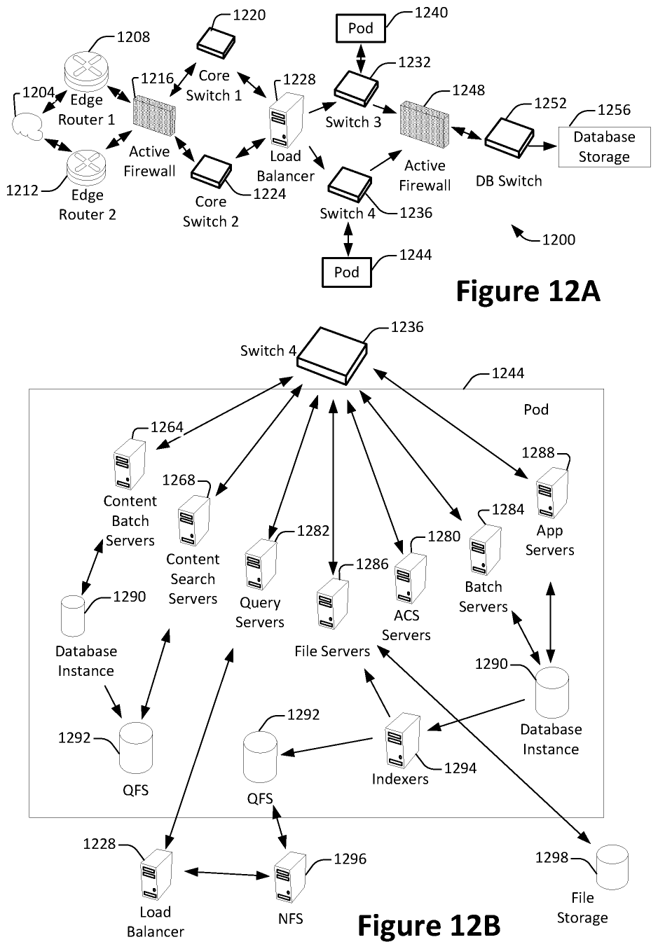

FIG. 12A shows a system diagram of an example of architectural components of an on-demand database service environment 1200, configured in accordance with some implementations. A client machine located in the cloud 1204 may communicate with the on-demand database service environment via one or more edge routers 1208 and 1212. A client machine may include any of the examples of user systems 1112 described above. The edge routers 1208 and 1212 may communicate with one or more core switches 1220 and 1224 via firewall 1216. The core switches may communicate with a load balancer 1228, which may distribute server load over different pods, such as the pods 1240 and 1244 by communication via pod switches 1232 and 1236. The pods 1240 and 1244, which may each include one or more servers and/or other computing resources, may perform data processing and other operations used to provide on-demand services. Components of the environment may communicate with a database storage 1256 via a database firewall 1248 and a database switch 1252.

Accessing an on-demand database service environment may involve communications transmitted among a variety of different components. The environment 1200 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 12A and 12B.

The cloud 1204 refers to any suitable data network or combination of data networks, which may include the Internet. Client machines located in the cloud 1204 may communicate with the on-demand database service environment 1200 to access services provided by the on-demand database service environment 1200. By way of example, client machines may access the on-demand database service environment 1200 to retrieve, store, edit, and/or process information.

In some implementations, the edge routers 1208 and 1212 route packets between the cloud 1204 and other components of the on-demand database service environment 1200. The edge routers 1208 and 1212 may employ the Border Gateway Protocol (BGP). The edge routers 1208 and 1212 may maintain a table of IP networks or ‘prefixes’, which designate network reachability among autonomous systems on the internet.

In one or more implementations, the firewall 1216 may protect the inner components of the environment 1200 from internet traffic. The firewall 1216 may block, permit, or deny access to the inner components of the on-demand database service environment 1200 based upon a set of rules and/or other criteria. The firewall 1216 may act as one or more of a packet filter, an application gateway, a stateful filter, a proxy server, or any other type of firewall.

In some implementations, the core switches 1220 and 1224 may be high-capacity switches that transfer packets within the environment 1200. The core switches 1220 and 1224 may be configured as network bridges that quickly route data between different components within the on-demand database service environment. The use of two or more core switches 1220 and 1224 may provide redundancy and/or reduced latency.

In some implementations, communication between the pods 1240 and 1244 may be conducted via the pod switches 1232 and 1236. The pod switches 1232 and 1236 may facilitate communication between the pods 1240 and 1244 and client machines, for example via core switches 1220 and 1224. Also or alternatively, the pod switches 1232 and 1236 may facilitate communication between the pods 1240 and 1244 and the database storage 1256. The load balancer 1228 may distribute workload between the pods, which may assist in improving the use of resources, increasing throughput, reducing response times, and/or reducing overhead. The load balancer 1228 may include multilayer switches to analyze and forward traffic.

In some implementations, access to the database storage 1256 may be guarded by a database firewall 1248, which may act as a computer application firewall operating at the database application layer of a protocol stack. The database firewall 1248 may protect the database storage 1256 from application attacks such as structure query language (SQL) injection, database rootkits, and unauthorized information disclosure. The database firewall 1248 may include a host using one or more forms of reverse proxy services to proxy traffic before passing it to a gateway router and/or may inspect the contents of database traffic and block certain content or database requests. The database firewall 1248 may work on the SQL application level atop the TCP/IP stack, managing applications' connection to the database or SQL management interfaces as well as intercepting and enforcing packets traveling to or from a database network or application interface.

In some implementations, the database storage 1256 may be an on-demand database system shared by many different organizations. The on-demand database service may employ a single-tenant approach, a multi-tenant approach, a virtualized approach, or any other type of database approach. Communication with the database storage 1256 may be conducted via the database switch 1252. The database storage 1256 may include various software components for handling database queries. Accordingly, the database switch 1252 may direct database queries transmitted by other components of the environment (e.g., the pods 1240 and 1244) to the correct components within the database storage 1256.

FIG. 12B shows a system diagram further illustrating an example of architectural components of an on-demand database service environment, in accordance with some implementations. The pod 1244 may be used to render services to user(s) of the on-demand database service environment 1200. The pod 1244 may include one or more content batch servers 1264, content search servers 1268, query servers 1282, file servers 1286, access control system (ACS) servers 1280, batch servers 1284, and app servers 1288. Also, the pod 1244 may include database instances 1290, quick file systems (QFS) 1292, and indexers 1294. Some or all communication between the servers in the pod 1244 may be transmitted via the switch 1236.

In some implementations, the app servers 1288 may include a framework dedicated to the execution of procedures (e.g., programs, routines, scripts) for supporting the construction of applications provided by the on-demand database service environment 1200 via the pod 1244. One or more instances of the app server 1288 may be configured to execute all or a portion of the operations of the services described herein.

In some implementations, as discussed above, the pod 1244 may include one or more database instances 1290. A database instance 1290 may be configured as an MTS in which different organizations share access to the same database, using the techniques described above. Database information may be transmitted to the indexer 1294, which may provide an index of information available in the database 1290 to file servers 1286. The QFS 1292 or other suitable filesystem may serve as a rapid-access file system for storing and accessing information available within the pod 1244. The QFS 1292 may support volume management capabilities, allowing many disks to be grouped together into a file system. The QFS 1292 may communicate with the database instances 1290, content search servers 1268 and/or indexers 1294 to identify, retrieve, move, and/or update data stored in the network file systems (NFS) 1296 and/or other storage systems.

In some implementations, one or more query servers 1282 may communicate with the NFS 1296 to retrieve and/or update information stored outside of the pod 1244. The NFS 1296 may allow servers located in the pod 1244 to access information over a network in a manner similar to how local storage is accessed. Queries from the query servers 1222 may be transmitted to the NFS 1296 via the load balancer 1228, which may distribute resource requests over various resources available in the on-demand database service environment 1200. The NFS 1296 may also communicate with the QFS 1292 to update the information stored on the NFS 1296 and/or to provide information to the QFS 1292 for use by servers located within the pod 1244.

In some implementations, the content batch servers 1264 may handle requests internal to the pod 1244. These requests may be long-running and/or not tied to a particular customer, such as requests related to log mining, cleanup work, and maintenance tasks. The content search servers 1268 may provide query and indexer functions such as functions allowing users to search through content stored in the on-demand database service environment 1200. The file servers 1286 may manage requests for information stored in the file storage 1298, which may store information such as documents, images, basic large objects (BLOBs), etc. The query servers 1282 may be used to retrieve information from one or more file systems. For example, the query system 1282 may receive requests for information from the app servers 1288 and then transmit information queries to the NFS 1296 located outside the pod 1244. The ACS servers 1280 may control access to data, hardware resources, or software resources called upon to render services provided by the pod 1244. The batch servers 1284 may process batch jobs, which are used to run tasks at specified times. Thus, the batch servers 1284 may transmit instructions to other servers, such as the app servers 1288, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

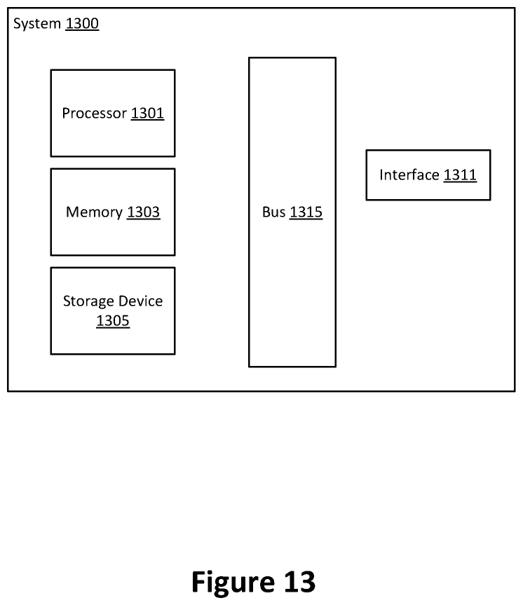

FIG. 13 illustrates one example of a computing device. According to various embodiments, a system 1300 suitable for implementing embodiments described herein includes a processor 1301, a memory module 1303, a storage device 1305, an interface 1311, and a bus 1315 (e.g., a PCI bus or other interconnection fabric.) System 1300 may operate as variety of devices such as an application server, a database server, or any other device or service described herein. Although a particular configuration is described, a variety of alternative configurations are possible. The processor 1301 may perform operations such as those described herein. Instructions for performing such operations may be embodied in the memory 1303, on one or more non-transitory computer readable media, or on some other storage device. Various specially configured devices can also be used in place of or in addition to the processor 1301. The interface 1311 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

What is claimed is:

1. A method comprising:
providing, via an on demand computing services environment implemented using database system using a server system, a computing platform to a plurality of organizations, the computing platform configurable to allow users to graphically represent relationships between database records of the database system;
processing, from a user first user associated with a first one of the organizations, a request to generate a customizable visualization for graphically representing relationships between a root database record and child database records related to the root database record in a customizable format, the root database record and child database records being stored in a database of the database system, the customizable format comprising one of a plurality of user-selectable configurations by which the relationships are graphically represented, the user-selectable configurations including a vertical configuration in which related database records are displayed substantially vertically adjacently and a horizontal configuration in which related database records are displayed substantially vertically adjacently; and
causing display, in a user interface of a computing device, graphical representations of the root database record and the child database records in accordance with the customizable format.

2. The method of claim 1, wherein the child database records are displayed in the user interface in a record container, the record container comprising graphical representations of further information related to the child database records, the graphical representations of the further information being automatically displayable in the user interface without user interaction with the graphical representations of the child database records.

3. The method of claim 1, wherein the child database records are displayed in the user interface in respective record cards in a record container, the respective record cards comprising information associated with both the child records and fields associated with further database records of the database system.

4. The method of claim 1, further comprising:
providing, based on an artificial intelligence system integrated with the computing system, recommendations of further relationships between database records.

5. The method of claim 1, wherein the visualization comprises a plurality of nodes; and the request from the first user is presented via a user interface configured to allow the first user to perform a combination of: selecting the root record and the child records, selecting a relationship type to be graphically represented in the visualization, configuring the nodes of the visualization, and configuring user-customizable actions associated with the visualization.

6. The method of claim 1, wherein the computing platform is configured to allow a user to choose a plurality of relationship graph templates that are created on behalf of the first organization and/or default templates that the computing platform has created across organizations implementing the computing platform.

7. The method of claim 1, wherein the customizable format further comprises pre-configurable visualization nodes associated with user-selectable fonts, colors, or brand-related elements to be included in the graphical representations of the root database record and the child database records.

8. The method of claim 7, wherein the computing platform is configured to allow each respective organization using the computing platform choose one or more user selectable fonts, colors, or brand-related elements to be included in graphical representations of relationships between database records of the database system on behalf of the respective organization.

9. A computing platform implemented using a server system, the computing platform being configurable to cause:
providing, via an on demand computing services environment implemented using database system using a server system, the computing platform to a plurality of organizations, the computing platform configurable to allow users to graphically represent relationships between database records of the database system;
processing, from a user first user associated with a first one of the organizations, a request to generate a customizable visualization for graphically representing relationships between a root database record and child database records related to the root database record in a customizable format, the root database record and child database records being stored in a database of the database system, the customizable format comprising one of a plurality of user-selectable configurations by which the relationships are graphically represented, the user-selectable configurations including a vertical configuration in which related database records are displayed substantially vertically adjacently and a horizontal configuration in which related database records are displayed substantially vertically adjacently; and
causing display, in a user interface of a computing device, graphical representations of the root database record and the child database records in accordance with the customizable format.

10. The computing platform of claim 9, wherein the child database records are displayed in the user interface in a record container, the record container comprising graphical representations of further information related to the child database records, the graphical representations of the further information being automatically displayable in the user interface without user interaction with the graphical representations of the child database records.

11. The computing platform of claim 9, wherein the child database records are displayed in the user interface in respective record cards in a record container, the respective record cards comprising information associated with both the child records and fields associated with further database records of the database system.

12. The computing platform of claim 9, the computing platform further configurable to cause:
providing, based on an artificial intelligence system integrated with the computing system, recommendations of further relationships between database records.

13. The computing platform of claim 9, wherein the visualization comprises a plurality of nodes; and the request from the first user is presented via a user interface configured to allow the first user to perform a combination of: selecting the root record and the child records, selecting a relationship type to be graphically represented in the visualization, configuring the nodes of the visualization, and configuring user-customizable actions associated with the visualization.

14. The computing platform of claim 9, wherein computing platform is configured to allow a user to choose a plurality of relationship graph templates that are created on behalf of the first organization and/or default templates that the computing platform has created across organizations implementing the computing platform.

15. The computing platform of claim 9, wherein the customizable format further comprises pre-configurable visualization nodes associated with user-selectable fonts, colors, or brand-related elements to be included in the graphical representations of the root database record and the child database records.

16. The computing platform of claim 15, wherein the computing platform is configured to allow each respective organization using the computing platform choose one or more user selectable fonts, colors, or brand-related elements to be included in graphical representations of relationships between database records of the database system on behalf of the respective organization.

17. A computer program product comprising non-transitory computer-readable program code capable of being executed by one or more processors when retrieved from a non-transitory computer-readable medium, the program code comprising instructions configurable to cause the one or more processors to perform a method comprising:
providing, via an on demand computing services environment implemented using database system using a server system, a computing platform to a plurality of organizations, the computing platform configurable to allow users to graphically represent relationships between database records of the database system;
processing, from a user first user associated with a first one of the organizations, a request to generate a customizable visualization for graphically representing relationships between a root database record and child database records related to the root database record in a customizable format, the root database record and child database records being stored in a database of the database system, the customizable format comprising one of a plurality of user-selectable configurations by which the relationships are graphically represented, the user-selectable configurations including a vertical configuration in which related database records are displayed substantially vertically adjacently and a horizontal configuration in which related database records are displayed substantially vertically adjacently; and
causing display, in a user interface of a computing device, graphical representations of the root database record and the child database records in accordance with the customizable format.

18. The computer program product of claim 17, wherein the child database records are displayed in the user interface in a record container, the record container comprising graphical representations of further information related to the child database records, the graphical representations of the further information being automatically displayable in the user interface without user interaction with the graphical representations of the child database records.

19. The computer program product of claim 17, wherein the child database records are displayed in the user interface in respective record cards in a record container, the respective record cards comprising information associated with both the child records and fields associated with further database records of the database system.

20. The computer program product of claim 17, the program code comprising instructions configurable to cause the one or more processors to:
provide, based on an artificial intelligence system integrated with the computing system, recommendations of further relationships between database records.
